(19) United States
(12) Patent Application Publication
(10) Pub. No.: US 2006/0294127 A1
(43) Pub. Date: Dec. 28, 2006

(54) Tagging based schema to enable processing of multilingual text data

(75) Inventor: William B. Nettles, San Jose, CA (US)

Correspondence Address: CANADY & LORTZ LLP- IBM, 2540 HUNTINGTON DRIVE, SUITE 205, SAN MARINO, CA, 91108, US

(73) Assignee: International Business Machines Corporation, San Jose, CA (US)

(21) Appl. No.: 11/170,801

(22) Filed: Jun. 28, 2005

(51) Int. Cl. G06F 7/00; G06F 15/16

(52) U.S. Cl. 707/101; 709/246

(57) ABSTRACT

Techniques for implementing encoding standard conversion at an access level are disclosed. Applications to retrieve and store data to external media and convert the accessed data according to tags applied to accessing of the data. A program having a buffer operable with data in a first encoding standard accesses data in a second encoding standard on a remote storage device managed by a host and the host converts the data to the first encoding standard as it is accessed to be received by the program buffer. The data in the program buffer remains encoded in the first standard and the data in the storage device remains encoded in the second standard as the program accesses it.

### BACKGROUND OF THE INVENTION

1. Field of the Invention

This invention relates to computer implemented systems and methods for exchanging data, e.g. between computer programs employing different encoding schemes. Particularly, the invention relates to systems and methods for exchanging data between different software platforms employing different encoding code pages.

2. Description of the Related Art

The inherently distributed direction of computing today has a pervasive impact on the supporting infrastructure of legacy systems. Information technology (IT) organizations are being transformed from using traditional mainframe legacy systems to distributed application server, web-centric configurations. For example, the virtual storage access method (VSAM) is a file management system used on IBM mainframe operating systems. Generally, VSAM speeds up access to data in files by using an inverted index (called a B+tree) of all records added to each file. Many legacy software systems use VSAM to implement database systems (called data sets). The migration of data from traditional data stores, such as those using VSAM, to other repositories, like those using database 2 (DB2) or other non-z/OS platforms, can introduce new data encoding requirements. The same conditions apply similarly to other legacy access methods such as the basic sequential access method (BSAM) and the queued sequential access method (QSAM). In some cases, the problem of accommodating multiple data encoding standards in multiple locations arises.

American standard code for information interchange (ASCII) is a code in which each alphanumeric character is represented as an 8-bit binary code for the computer. ASCII is used by most microcomputers and printers and on the Internet. Using ASCII, text-only files can be transferred easily between different types of computers. For the representation of national language characters, sets of different ASCII codepages are defined. Similarly, extended binary coded decimal interchange code (EBCDIC) is an 8-bit binary code for larger IBM computers in which each byte represents one alphanumeric character. Different EBCDIC codepages are defined to represent national language characters.

On the other hand, Unicode is an encoding type designed to accomodate all characters in all writing systems. Originally, Unicode provided a character set that employed 16 bits (two bytes) in the Unicode transformation format 16 (UTF-16) for each character. However, it became necessary to evolve Unicode to utilize an extenstion mechanism using pairs of Unicode values called surrogates to expand the number of possible characters. In addition, two additional Unicode forms were developed, UTF-32 for systems more capable of handling larger units of 32 bits for representing Unicode, and UTF-8 for system that could not easily handle extending their interfaces to use 16-bit units in processing. Thus, Unicode is able to include more characters than ASCII or EBCDIC. For example, UTF-16 can have 65,536 characters, and therefore can be used to encode almost all the languages of the world. Unicode includes the ASCII character set within it.

Increasingly today, the aforementioned migration of data introduces Unicode as the encoding standard along with the existing single byte variants of EBCDIC and ASCII encodings. Typically, the underlying infrasucture was not designed to support this activity and often provides limited or no support at all for this migration. Current conditions add complexity and expense to the legacy transformation efforts in terms of more anomolus conditions that must be accommodated and consequently higher levels of programming effort required. Some previous efforts to accommodate multiple data coding standards have been described.

U.S. Pat. No. 6,658,625 by Paul V. Allen, issued Dec. 2,2003, provides a method and apparatus for generic data conversion. A generic data convertor interprets a data description that has configurable data definitions that can accommodate changes in the data The data definitions can allow the data type, character set, location, and length of data elements in the data stream or file to be described and easily modified. The data convertor uses the data description to determine how to convert the data and, if necessary, where data elements are in the data. The data convertor is particularly useful for converting data that is sent to and/or received from a server. The data convertor and data description cooperate to support calling multiple releases of the server using the same data description. In addition, the data convertor may also call the server program with the correct, converted parameters in the correct order. The data convertor usually waits until a requesting application asks for particular data elements in the data before converting the data elements.

U.S. Patent Application Publication 2004/0003119 by Munir et al., published Jan. 1, 2004 discloses the capability to transfer files to and edit files in an integrated development environment. The source files may be located on a remote computer system across a network, such as the Internet. The local system upon which the integrated development environment is executing and the remote system having the source files may have different operating systems, different geographical locations with different human languages, and/or different programming languages. The disclosure requests the source file on the remote system and then encodes the differences between the languages and/or the operating system by reading the extension of the source file. These encoded differences are translated when the remote file is opened in the local integrated development environment with an editor. The editor may be a LPEX editor if the files are members of an OS/400 operating system, or the editor may be an operating system editor for a file having the source file's extension, or a default text editor. The edited file is encoded for use on the remote system and then transferred to the remote system.

However, there is still a need in the art for systems and methods for facillitating use of data encoded in multiple formats, particularly in a distributed computer system. In addition, there is a need for such systems and methods to accommodate multiple encoding formats (including the various forms of Unicode, UTF-8, UTF-16 and UTF-32 and related variants) at a system level within such a distributed computer system in a manner that is transparent to the storage access method. There is also a need for such systems and methods to provide access level support for applications and compilers with mainfiame service quality. As detailed hereafter, these and other needs are met by the present invention.

### SUMMARY OF THE INVENTION

Embodiments of the present invention offload at least a portion of the data conversion complexity from the application level of the system and provide access level support with mainframe service quality. Further, embodiments of the invention provide a framework that enables an application to not only access (read or write, i.e. GET or PUT) data to the external media, but also to convert the data according to “tags” provided to direct the conversion processing.

A typical embodiment of the invention comprises a computer program embodied on a computer readable medium and including program instructions for opening a conversion service in response to a flag from an application accessing data on a remote storage device. The flag comprises one or more tags set by the application where the one or more tags identify an application encoding standard and a storage encoding standard. In addition, program instructions are included for the conversion service to convert the data between an access method buffer where the data is in the application encoding standard and the storage buffer where the data is in the storage encoding standard. The conversion service may operate on a host while the application operates on a client and the host and the client are communicatively coupled.

In a typical embodiment, the flag comprises setting the one or more tags by the application. The one or more tags may be character code set identifiers (CCSIDs) and typically comprise a first tag identifying the application encoding standard and a second tag identifying the storage encoding standard.

Accessing the data on the remote storage device may involve either a GET or PUT process. For example, accessing the data comprises a GET process where the data is read from the remote storage device converted and communicated to a program buffer within the application. Accessing the data comprises a PUT process where the data is written to the remote storage device after being converted and communicated from a program buffer within the application.

Similarly, embodiments of the invention may be framed from the client perspective where a computer program embodied on a computer readable medium, comprises program instructions for opening a conversion service by generating a flag and accessing data on a remote storage device. The flag includes one or more tags where the one or more tags identify an application encoding standard and a storage encoding standard. Program instructions are also included for communicating with the conversion service to access the data where the conversion service converts the data between an access method buffer where the data is in the application encoding standard and the storage buffer where the data is in the storage encoding standard. A client embodiment of the invention may be modified consistent with the host embodiment described above.

In addition, embodiments of the invention include a method comprising opening a conversion service in response to an application accessing data on a remote storage device and setting one or more tags where the one or more tags identify an application encoding standard and a storage encoding standard and converting the data between an access method buffer where the data is in the application encoding standard and the storage buffer where the data is in the storage encoding standard. Method embodiment of the invention may also be modified consistent with the host embodiment described above.

### BRIEF DESCRIPTION OF THE DRAWINGS

Referring now to the drawings in which like reference numbers represent corresponding parts throughout:

FIG. 1A illustrates an exemplary computer system that can be used to implement embodiments of the present invention;

FIG. 1B illustrates a typical distributed computer system which may be employed in an typical embodiment of the invention;

FIG. 2A illustrates a general embodiment of the invention applying tags to implement an access level data conversion;

FIG. 2B depicts an exemplary embodiment of the invention; and

FIG. 3 is a flowchart of an exemplary method of the invention.

### DETAILED DESCRIPTION OF THE PREFERRED EMBODIMENT

1. Overview

As mentioned above, embodiments of the present invention offload at least a portion of the data conversion complexity from the application level of the system and provide access level support with mainframe service quality. Data conversion is performed as an application accesses data (i.e. on the fly). Further, embodiments of the invention provide a framework that enables an application to not only access (read or write) data to the external media, but also to convert the data according to “tags” provided to direct the conversion processing.

The term “tag” within the context of the present description refers to a value which specifies the data encoding for a particular file. For example, a tag may comprise a a 16-bit character code set identifier (CCSID) in a typical embodiment of the invention. Various embodiments of the invention employ an access method which implements a CCSID to CCSID conversion schema as described herein.

Typically, by implementing a character code set identifier (CCSID) based tagging schema, the access methods (e.g. VSAM, BSAM, QSAM, etc.), allow CCSID to CCSID conversions primarily to assist applications and compilers (e.g. Cobol, PL/1) in handling various data encoding standards, such as Unicode data. In this way, legacy programs utilizing a first encoding standard may support new access methods and operating systems. Software applications and/or languages utilizing an embodiment of the invention may provide an indication (such as the setting of a tag) that this new level of conversion support is being engaged. Particularly, they may provide a first tag that specifies the first encoding standard output from the conversion process as well as a second tag that specifies a second data encoding standard of the file. In some cases, the default tag schema may eliminate the need to explicitly define both tags. The conversions would have to be supported by the platform services that are invoked as appropriate for the access method or an error condition is indicated.

2. Hardware Environment

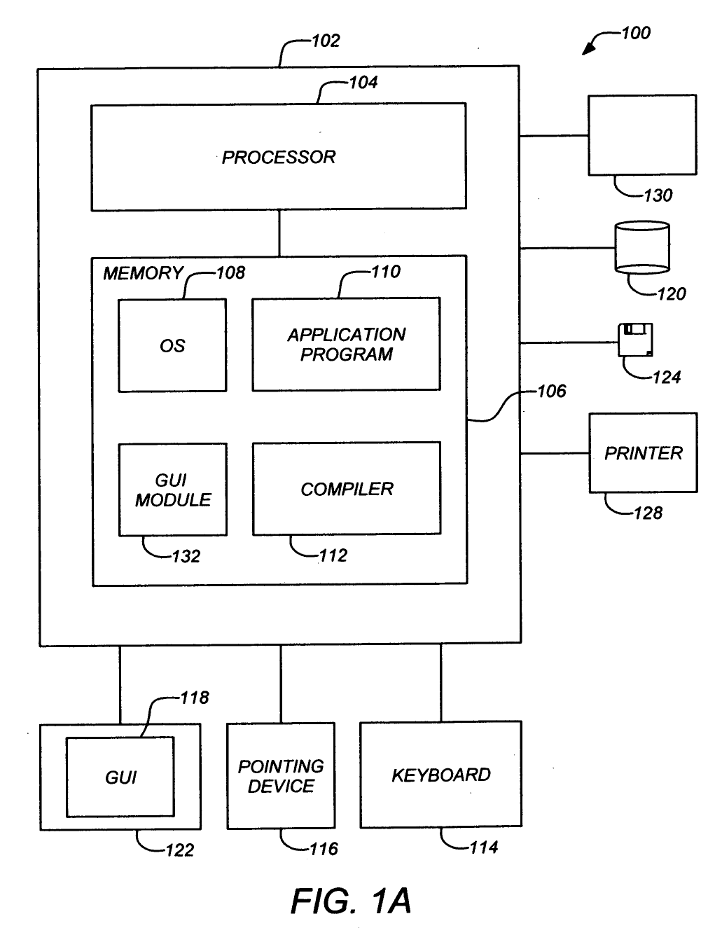

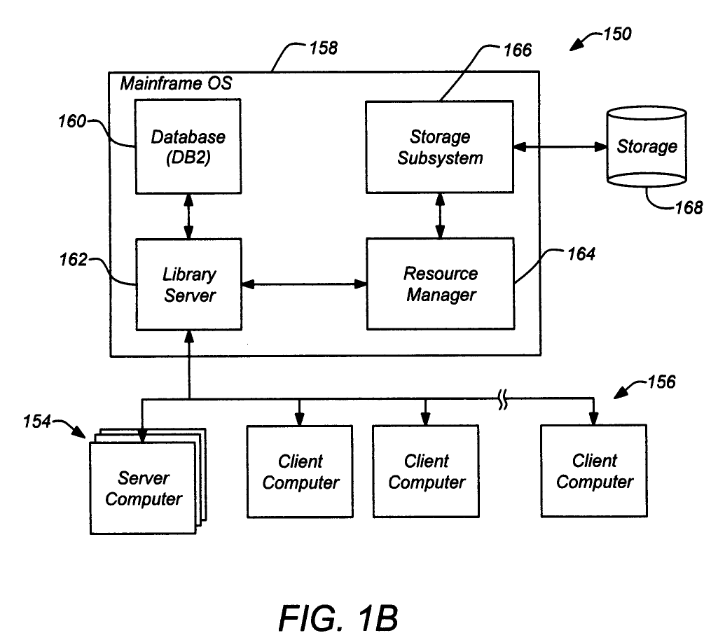

FIG. 1A illustrates an exemplary computer system 100 that can be used to implement embodiments of the present invention. The computer 102 comprises a processor 104 and a memory 106, such as random access memory (RAM). The computer 102 is operatively coupled to a display 122, which presents images such as windows to the user on a graphical user interface 118. The computer 102 may be coupled to other devices, such as a keyboard 114, a mouse device 116, a printer, etc. Of course, those skilled in the art will recognize that any combination of the above components, or any number of different components, peripherals, and other devices, may be used with the computer 102.

Generally, the computer 102 operates under control of an operating system 108 (e.g. z/OS, OS/2, LINUX, UNIX, WINDOWS, MAC OS) stored in the memory 106, and interfaces with the user to accept inputs and commands and to present results, for example through a graphical user interface (GUI) module 132. Although the GUI module 132 is depicted as a separate module, the instructions performing the GUI functions can be resident or distributed in the operating system 108, the computer program 110, or implemented with special purpose memory and processors. The computer 102 also implements a compiler 112 which allows an application program 110 written in a programming language such as CQBOL, PL/1, C, C++, JAVA, ADA, BASIC, VISUAL BASIC or any other programming language to be translated into code readable by the processor 104. After completion, the computer program 110 accesses and manipulates data stored in the memory 106 of the computer 102 using the relationships and logic that was generated using the compiler 112. The computer 102 also optionally comprises an external data communication device 130 such as a modem, satellite link, ethernet card, wireless link or other device for communicating with other computers, e.g. via the Internet or other network.

In one embodiment, instructions implementing the operating system 108, the computer program 110, and the compiler 112 are tangibly embodied in a computer-readable medium, e.g., data storage device 120, which could include one or more fixed or removable data storage devices, such as a zip drive, floppy disc 124, hard drive, DVD/CD-rom, digital tape, etc. Further, the operating system 108 and the computer program 110 comprise instructions which, when read and executed by the computer 102, cause the computer 102 to perform the steps necessary to implement and/or use the present invention. Computer program 110 and/or operating system 108 instructions may also be tangibly embodied in the memory 106 and/or transmitted through or accessed by the data communication device 130. As such, the terms “article of manufacture,” “program storage device” and “computer program product” as may be used herein are intended to encompass a computer program accessible and/or operable from any computer readable device or media

FIG. 1B illustrates a typical distributed computer system 150 which may be employed in an typical embodiment of the invention. Such a system 150 comprises a plurality of computers 102 which are interconnected through respective communication devices 130 in a network 152. The network 152 may be entirely private (such as a local area network within a business facility) or part or all of the network 152 may exist publicly (such as through a virtual private network (VPN) operating on the Internet). Further, one or more of the computers 102 function may be specially designed to function server or host 154 facilitating a variety of services provided to the remaining client computers 156. In one example one or more hosts may be a mainframe computer 158 where significant processing for the client computers 156 may be performed. The mainframe computer 158 may comprise a database 160 which is coupled to a library server 162 which implements a number of database procedures for other networked computers 102 (servers 154 and/or clients 156). The library server 162 is also coupled to a resource manager 164 which directs data accesses through storage subsystem 166 facilitates accesses to one or more coupled storage devices 168 such as direct access storage devices (DASD) optical storage and/or tape storage. Various access methods (e.g. VSAM, BSAM, QSAM) as discussed hereafter may function as part of the storage subsystem 166.

Those skilled in the art will recognize many modifications may be made to this configuration without departing from the scope of the present invention. For example, those skilled in the art will recognize that any combination of the above components, or any number of different components, peripherals, and other devices, may be used with the present invention meeting the functional requirements to support and implement various embodiments of the invention described herein.

3. Tag Based Schema and Multilingual Text Data

File tagging has been previously applied for automatic conversion of data or files at an application level. For example, U.S. Patent Application Publication 2001/0037337 by Maier et al., published Nov. 1, 2001, which is incorprated by reference herein, provides facilities for tagging files or data with attribute information in the form of a file tag (TAGINFO) which contains an identifier for text information (TXTFLAG) and an attribute (CCSID) for identifying encoding schemes. TXTFLAG is an auto conversion flag that inhibits automatic conversion between encoding schemes when switched off, while CCSID is an encoding scheme identifier. Furthermore, a runtime attribute (process CCSID) is assigned to a process specifying the runtime encoding scheme. A conversion is done automatically by an auto conversion function if both CCSIDs allow a conversion. Files having no file tag are tagged with a virtual file tag (default tag) by means of an automatic tagging (AUTOTAG) function using heuristic rules for determining whether the data or file contains text or binary information. Old applications must work with untagged files as before. Existing applications should be able to benefit from auto conversion and thereby be enabled to process new, tagged files without code changes. The invention allows a user to physically store data in the process codepage of the application thereby avoiding any conversions in the frequently used path while the file tagging and auto conversion does not inhibit other programs running in a different codepage to access the data.

Embodiments of the present invention implement code conversion at a low level; rather than implementing code conversion at an application level as is typical of the prior art, embodiments of the present invention implement code conversion at an access method level. For example, prior art techniques may identify encoding through file extension, whereas embodiments of the present invention operate without relying on file extensions. Thus, a program having a buffer operable with data in a first encoding standard accesses data in a second encoding standard on a storage device managed by a host and the host converts the data to the first encoding standard as it is accessed to be received by the program buffer. The data in the program buffer remains encoded in the first standard and the data in the storage device remain encoded in the second standard as the program accesses it. In addition, embodiments of the invention enable applications to retrieve and store data to external media and convert the accessed data according to tags applied to accessing of the data.

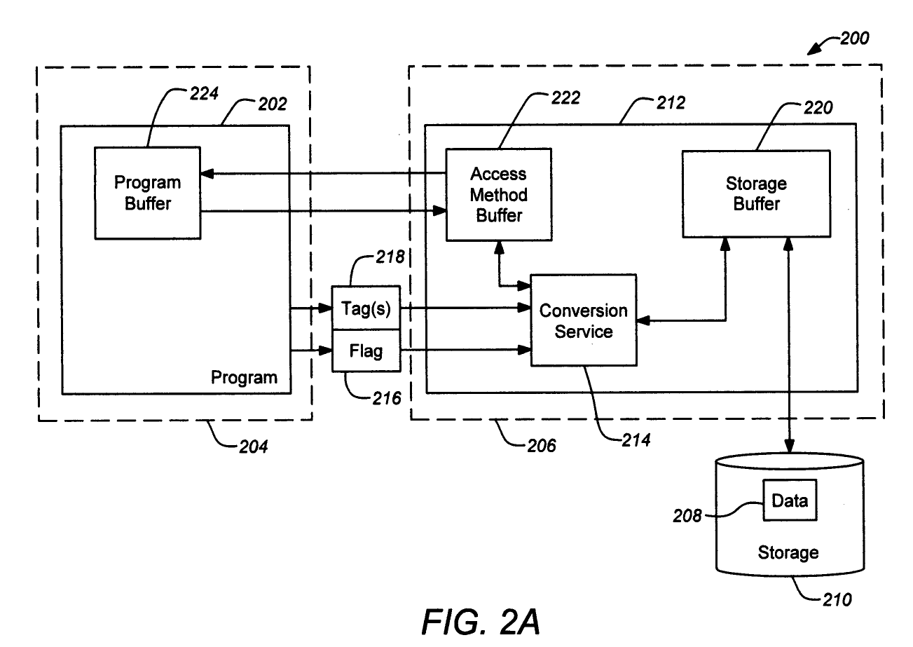

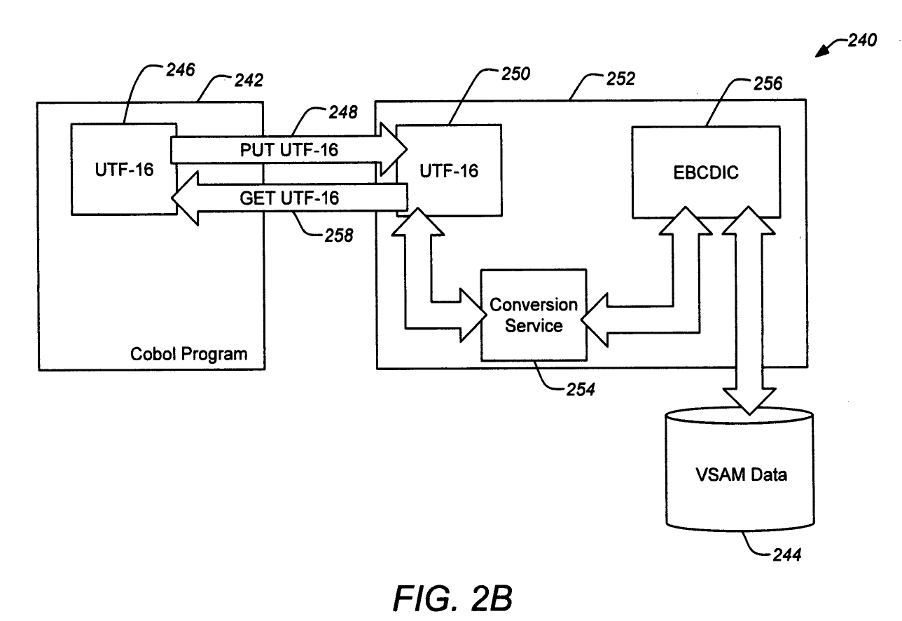

FIG. 2A illustrates a general embodiment of the invention applying tags to implement an access level data conversion. The system 200 includes a program or application 202 operating on a client computer 204 and supported by a server or mainframe host 206 as previously described in the hardware environment above. The application 202 initiates an OPEN operation to access data 208 (e.g. a file) on a storage device 210 managed by the access method 212 on the host 206.

The conversion service 214 may be invoked by the access method 212 as needed in response to some trigger condition or flag 216 being created as part of the file access. The flag 216 or condition may be simply the setting of one or more particular parameters or tags 218 to specify the applied conversion. In this way, the flag 216 becomes the setting of particular tags 218 by the application 202 in order to open the conversion service 214. However, the file structure may also play a role.

In one example embodiment, under the integrated catalog facility (ICF) the volume table of contents (VTOC) comprises a plurality of data set control blocks (DSCBs) as is known in the art. Some of the DSCBs comprise file descriptors associated with each file (data 208) on the storage device 210 which include various parameters associated with each file. Embodiments of the invention may include appropriate supporting structure within the ICF catalog associated with each file to allow the automatic conversion activity to take place with that file. One of the elements of this supporting structure is a number of catalogued attributes including the CCSID for the file. The catalogued CCSID specifies the encoding of the data in the file, that is interrogated during the processing leading to conversion. In addition, at least one bit within an appropriate DSCB associated with each file which is interrogated upon access by an application 202 to confirm enablement of the conversion service 214. If the bit is OFF, the supporting structure is first created in the ICF Catalog before conversion processing continues. If the bit is ON, the creation process is bypassed; this creation process is only required once for each file. Thereafter, the structure is always available for that file.

The one or more tags 218 specify the encoding standard of the application 202 as well as the encoding standard of the storage device 210. Typically, two tags are set by the application 202, one tag to indicate the encoding standard required by the application 202 and another tag to indicate the encoding standard of the file on the storage device 210. The access method 212 which receives the tags from the application 202, may compare the tag that specifies the intended encoding for the file to any pre-existing tag in the catalog to confirm that the tag from the application (referring to the encoding standard of the file) matches the encoding standard indicated by the tag previously set in the catalog. If a the same encoding standard is not indicated, the access method 212 aborts the operation and returns an error message. In some embodiments, a default tag schema can eliminate the need to define both tags 218.

Accesses of a file 208 by the application 202 can occur in either a read or write context (i.e. a GET or PUT process, respectively). Accessing the data in read context, the application 202 initiates a GET process where the data 208 is read from the remote storage device 210 in the storage encoding standard converted and communicated to a program buffer 224 within the application 202 in the application encoding standard. Accessing the data in a write context, the application initiates a PUT process where the data 208 is written to the remote storage device 210 in the storage encoding standard after being converted and communicated from a program buffer 224 within the application 202 in an application encoding standard. In operation, the conversion service 214 operates between data in a storage buffer 220 and data in an access method buffer 222.

In a GET process, data 208 from the storage device 210 is communicated to a storage buffer 220 within the access method 212 in the storage encoding standard. The conversion service converts the data in the storage buffer 220 from the storage encoding standard to the application encoding standard and communicates the result to an access method buffer 222. The access method buffer 222 is coupled to the application 202 and the converted data in the access method buffer 222 is communicated to the program buffer 224 within the application 202.

In a PUT process, data from the program buffer 224 within the application 202 is communicated to the access method buffer 222 within the access method 212 in an application encoding standard. The conversion service then converts the data in the access method buffer 222 from the application encoding standard to the storage encoding standard and communicates the result to a storage buffer 220. The storage buffer 220 then communicates the converted data to be written to the storage device 210.

In an exemplary embodiment, by implementing tags in a character code set identifier (CCSID) based tagging schema, the access methods (e.g. VSAM, BSAM, QSAM, etc.), allow CCSID to CCSID conversions to assist applications and compilers (e.g. Cobol, PL/1) in handling various data encodings such as Unicode data. Software applications and languages utilizing an embodiment of the invention may provide an indication (such as the setting of tags) that this new level of conversion support is being engaged. Particularly, they may provide a first tag that specifies the output of the conversion as well as a second tag that specifies the data encoding in the file. In some cases, the default schema may eliminate the need to explicitly define both tags. The conversions would have to be supported by the platform services that are invoked as appropriate by the access method.

FIG. 2B depicts an exemplary embodiment of the invention. In the mainframe client system 240, the application 242, a Cobol program, first initiates an OPEN function to connect to a file on the VSAM data storage 244 with conversion enabled. The storage encoding standard is EBCDIC while the application encoding standard is Unicode (e.g. in UTF-16 format). Accordingly, the application 242 then can GET or PUT EBCDIC data, e.g. VSAM data, from or to the storage device 244. The program buffer 246 comprises Unicode data at all times and the storage device 244 comprises EBCDIC data in all cases. The PUT UTF-16 operation 248 transfers Unicode data to a buffer 250 of the access method 252. The data is converted by invoking the operating system conversion services component 254 and the EBCDIC result placed into another buffer 256. The resultant EBCDIC buffer 256 is transferred to the VSAM storage device 244. The GET UTF-16 operation 258 functions in the reverse manner of the PUT operation 248. It is important to note that embodiments of the invention which employ Unicode are not limited to UTF-16, but are operable with any Unicode form.

The OPEN function connects to the file on the storage device 244 and specifies the “from” and “to” tags that control the conversion process. The specification of the tags is the flag that indicates the enabled path. In the example above, the “from” tag indicates EBCDIC encoding and the “to” tag indicates Unicode encoding (e.g. UTF-16 format). In this example, the data on the storage device 244 is EBCDIC and the data coming from the application 242 and delivered to the application is Unicode. The CLOSE function is a process which disconnects the application 242 from the file on the storage device 244 and ends the data access.

The GET function requests to get data from the storage device 244 retrieves EBCDIC data that is routed through the platform conversion component 254. The output from the conversion is placed in the outbound buffer 250 and delivered to the application 242. Processing for the PUT operation is the reverse of GET operation. Unicode data is sent from the application 242 to the receiving buffer 250 of the access method. This data is routed through the platform conversion component 254. The output of this conversion is placed in the EBCDIC buffer 256 and subsequently written to the storage device 244.

Note that embodiments of the invention are not limited to conversions such as described the foregoing scenario. The scenario is presented for illustrative purposes only. The tags may represent any valid combination of CCSIDs that can be accomodated by the platform conversion component. Anomolus results such as differences in length between the input data and converted data can be addressed by the individual access methods buffer handling and input/output routines as will be understood by those skilled in the art. The data written to the disc does not have to be EBCDIC. The data written to the disc is specified by the tag associated with the write. However, the access method should insure that if non-EBCDIC data is written to the disc, that fact should be noted by setting the tag in the appropriate repository, e.g. the integrated catalog facility (ICF) catalog in the case of multiple virtual storage (MVS) in IBM mainframe systems.

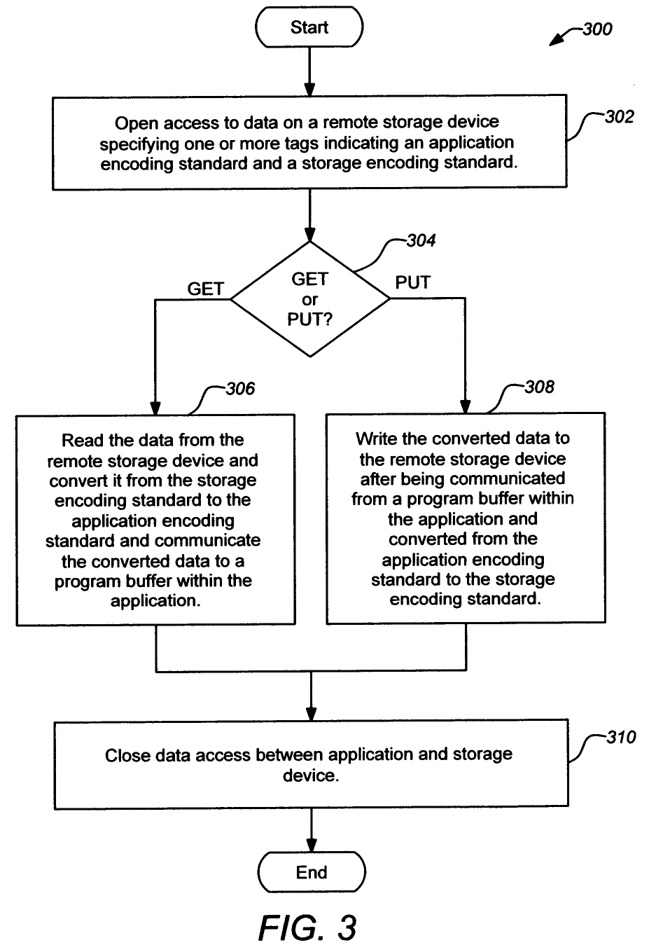

FIG. 3 is a flowchart of an exemplary method 300 of the invention. In a first operation 302, an application opens access to data on a remote storage device specifying one or more tags indicating an application encoding standard and a storage encoding standard. Operation 304 is a decision block determining whether a GET or PUT data access is being performed. The outcome of the decision may be determined by the tags set by the application. If a GET data access is indicated, operation 306 directs the data is read from the remote storage device converted from the storage encoding standard to the application encoding standard and communicated to a program buffer within the application. If a PUT data access is indicated, operation 308, directs the data is written to the remote storage device after being communicated from a program buffer within the application and converted from the application encoding standard to the storage encoding standard. In either case, following the conversion and transfer, in operation 310 the data access is closed. This method 300 may be further modified consistent with the program embodiments and examples described above.

This concludes the description including the preferred embodiments of the present invention. The foregoing description including the preferred embodiment of the invention has been presented for the purposes of illustration and description. It is not intended to be exhaustive or to limit the invention to the precise forms disclosed. Many modifications and variations are possible within the scope of the foregoing teachings. Additional variations of the present invention may be devised without departing from the inventive concept as set forth in the following claims.

What is claimed is:

1. A computer program embodied on a computer readable medium, comprising:
program instructions for opening a conversion service in response to a flag from an application accessing data on a remote storage device, the flag comprising one or more tags set by the application where the one or more tags identify an application encoding standard and a storage encoding standard; and
program instructions for the conversion service to convert the data between an access method buffer where the data is in the application encoding standard and the storage buffer where the data is in the storage encoding standard.

2. The computer program of claim 1, wherein the flag comprises setting the one or more tags by the application.

3. The computer program of claim 1, wherein the one or more tags comprise a first tag identifying the application encoding standard and a second tag identifying the storage encoding standard.

4. The computer program of claim 1, wherein the one or more tags comprise one or more character code set identifiers (CCSIDs).

5. The computer program of claim 1, wherein the conversion service operates on a host and the application operates on a client and the host and the client are communicatively coupled.

6. The computer program of claim 1, wherein accessing the data comprises a GET process where the data is read from the remote storage device converted and communicated to a program buffer within the application.

7. The computer program of claim 1, wherein accessing the data comprises a PUT process where the data is written to the remote storage device after being converted and communicated from a program buffer within the application.

8. A computer program embodied on a computer readable medium, comprising:
program instructions-for opening a conversion service by generating a flag and accessing data on a remote storage device, the flag comprising one or more tags where the one or more tags identify an application encoding standard and a storage encoding standard; and
program instructions for communicating with the conversion service to access the data where the conversion service converts the data between an access method buffer where the data is in the application encoding standard and the storage buffer where the data is in the storage encoding standard.

9. The computer program of claim 8, wherein generating the flag comprises setting the one or more tags.

10. The computer program of claim 8, wherein the one or more tags comprise a first tag identifying the application encoding standard and a second tag identifying the storage encoding standard.

11. The computer program of claim 8, wherein the one or more tags comprise one or more character code set identifiers (CCSIDs).

12. The computer program of claim 8, wherein the conversion service operates on a host and the application operates on a client and the host and the client are communicatively coupled.

13. The computer program of claim 8, wherein accessing the data comprises a GET process where the data is read from the remote storage device converted and communicated to a program buffer within the application.

14. The computer program of claim 8, wherein accessing the data comprises a PUT process where the data is written to the remote storage device after being converted and communicated from a program buffer within the application.

15. A method, comprising:
opening a conversion service in response to an application accessing data on a remote storage device and setting one or more tags where the one or more tags identify an application encoding standard and a storage encoding standard; and
converting the data between an access method buffer where the data is in the application encoding standard and the storage buffer where the data is in the storage encoding standard.

16. The method of claim 15, wherein the one or more tags comprise a first tag identifying the application encoding standard and a second tag identifying the storage encoding standard.

17. The method of claim 15, wherein the one or more tags comprise one or more character code set identifiers (CCSIDs).

18. The method of claim 15, wherein the conversion service operates on a host and the application operates on a client and the host and the client are communicatively coupled.

19. The method of claim 15, wherein accessing the data comprises a GET process where the data is read from the remote storage device converted and communicated to a program buffer within the application.

20. The method of claim 15, wherein accessing the data comprises a PUT process where the data is written to the remote storage device after being converted and communicated from a program buffer within the application.
